(19) United States
(12) Patent Application Publication
(10) Pub. No.: US 2010/0030520 A1
(43) Pub. Date: Feb. 4, 2010

(54) System for Real-Time Object Detection and Interception

(76) Inventors: Jarrell D. Collier, Sherman Oaks, CA (US); Michael P. Davenport, Camarillo, CA (US); H.K. John Armenian, Sherman Oaks, CA (US)

Correspondence Address: Arent Fox LLP, 555 West Fifth Street, 48th Floor, Los Angeles, CA, 90013, US

(21) Appl. No.: 12/184,096

(22) Filed: Jul. 31, 2008

(51) Int. Cl. G06F 17/18

(52) U.S. Cl. 702/181

(57) ABSTRACT

A system for determining a probability of interception by an interceptor of an object to be intercepted is disclosed herein. The system includes means for propagating a kinematic state of the object to be intercepted; means for determining a plurality of probabilities of intercept; means for determining whether an intercept is feasible and creating a set of probabilities of successful intercept for each probability of intercept; and means for determining the mean and variance of probability of successful intercept based on the set of probabilities of successful intercept.

### BACKGROUND

I. Field

The following description relates generally to real-time probabilistic predictions for future events and conditions as used for resource deployment and planning in defense and security applications, and more particularly to a system for real-time object detection and interception.

II. Background

There are numerous application domains where a need exists to determine, based on real time sensing and detection, a probabilistic determination of some future event or condition. One area that needs to be addressed is predicting some future event or condition based on detected data from sensors or other input sources (also referred to as current state information), where the current state information has some measure of uncertainty associated with it.

In security and defense applications there are at least two primary functions that require probabilistic prediction. One primary function is the evaluation of a threat, such as an object to be evaluated, to determine the nature of the threat. For example, part of the determination of the nature of the threat is the potential damage the object to be intercepted may cause to a threatened asset.

The second primary function that requires probabilistic prediction is an analysis of the probability that the object to be intercepted can be successfully intercepted using the deployment of a selected defensive resource. For example, there may be multiple defensive resources that can be deployed to intercept the object to be intercepted. Each can be evaluated on its own to determine the probability of a successful intercept. In addition, combinations of thereof can be evaluated as well.

The solutions to addressing these two functions take on different forms depending upon the source of the uncertainty in each function. In one instance, for systems that operate in real-time, where, for example, information is gathered about a real, ongoing situation and processed as it is received, the primary source of uncertainty is generated by a sensor or sensor system that provides kinematic state information and possibly other types of information about an object to be intercepted. For example, sensors can be based on radar, infrared, image, acoustic, or anything that is capable of providing a measurement from which kinematic state information can be derived. The error can be due to electrical or mechanical noise generated by the sensor, discretization (approximation) error due to sampling, and, in some cases, distortion of the signal to do the medium through which the signal travels.

One important measure of performance of any system that operates under a real-time environment is the ability to effectively balance the tradeoff between accuracy of the solution and the processing resources required to obtain the solution. For example, due to the real-time nature of the situation under which the system has to operate, the system does not have unlimited processing time nor resources. Accuracy achieved at the cost of processing resources is undesirable in the system. On the opposite extreme, a complete sacrifice of accuracy is also undesirable as other down-stream resources will be wasted if the solution is not accurate.

Consequently, it would be desirable to address one or more of the deficiencies described above.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to systems and/or methods that provide for determining a probability of interception by an interceptor of an object to be intercepted. In one aspect, the system comprises means for propagating a kinematic state of the object to be intercepted; means for determining a plurality of probabilities of intercept; means for determining whether an intercept is feasible and creating a set of probabilities of successful intercept for each probability of intercept; and means for determining the mean and variance of probability of successful intercept based on the set of probabilities of successful intercept.

In another aspect, a method for determining a probability of interception by an interceptor of an object to be intercepted is disclosed. The method including propagating a kinematic state of the object to be intercepted; determining a plurality of probabilities of intercept; for each probability of intercept, determining whether an intercept is feasible and creating a set of probabilities of successful intercept; and determining the mean and variance of probability of successful intercept based on the set of probabilities of successful intercept.

In still another aspect, a system for real-time determination of interception probability for a threatening object by an interceptor includes an objects kinetics information storage unit configured to store a kinematic state of the object to be intercepted; an intercept probability determination unit configured to determine a plurality of probabilities of intercept for the object to be intercepted; and, a variance and means determination unit configured to determine the mean and variance of probability of successful intercept based on the set of probabilities of successful intercept.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a system diagram illustrating a system for real-time detection and interception of an object to be intercepted, configured in accordance with one desired approach.

FIG. 2 is a flow diagram illustrating the operation of the real-time object detection and interception system for the object to be intercepted to determine a conditional mean and variance of the probability of the kinematic state of the object to be intercepted.

FIG. 3 is a diagram that illustrates a possible intercept endgame geometry during the interception of the object to be intercepted.

FIG. 4 is a graph that illustrates a conditional probability of successful intercept based on contact angle and closing speed.

FIG. 5 is a flow diagram illustrating a probabilistic approach for determining probability of successful intercept for an object to be intercepted in the real-time object detection and interception system.

FIG. 6 is a block diagram of a computer system usable in the real-time object detection and interception system of FIG. 1.

### DETAILED DESCRIPTION

A system providing a real-time probabilistic prediction mechanism is described herein that is adapted to address the probabilistic implementations discussed above. The described mechanism provides a better balance between the tradeoffs of accuracy versus computational resources than the prior art, which makes it suitable for real-time applications, and in some cases offers a simpler path to implementation as well. In one exemplary embodiment, the real-time probabilistic prediction mechanism is implemented as a system for real-time object detection and interception. Specifically, the system provides a determination of a probability of intercept of an object to be intercepted using an intercepting object, also known as an interceptor.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

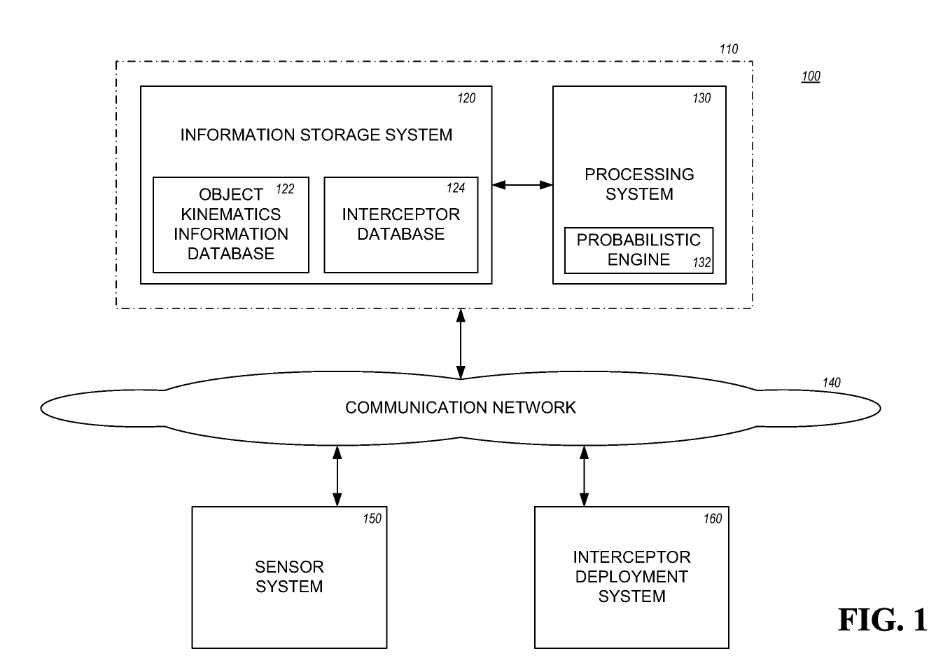

FIG. 1 illustrates a system diagram in which a real-time object detection and interception system 100 may be implemented in accordance with one aspect of the present disclosure, including a server system 110 having a processing system 130 that includes a probabilistic engine 132. The processing system 130 is coupled to an information storage system 120 that includes an object kinematics information database 122 and an interceptor database 124. A sensor system 152 is coupled for communicating with the server system 110 through a communication network 140. Further, an interceptor deployment system 160 is coupled to the communication network 140 to be controlled by the server system 160.

The probabilistic engine 132 interacts with other application software on the processing system 130 and the information storage system 120 to perform the probabilistic determination as described herein, including processing information received from the sensor system 150. The probabilistic engine 132 may access and present information from, as well as store information into, the information storage system 120. A user, using a client user interface (not shown), interacts with the server system 110. Multiple server systems and clients, as well as other computer systems (not shown) may also be coupled to the server system 110. Further, although the server system 110 is presented as two systems; with the processing system 130 residing on one system, and the information storage system 120 (including the object kinematics information database 122) residing on another system, the probabilistic functionality provided herein may be deployed using a single server system or may be spread over multiple systems.

In the illustrated example, the communications network 140 represents a variety of networks that may include one or more local area networks as well as wide area networks. The functionality provided by the information storage system 120, the processing system 130, as well as by any other computer systems necessary in the probabilistic system may be implemented using a computer system having the characteristics of the computer system described further herein. It should be noted, however, that the specific implementation of the computer system or systems used to describe the present system is not to be limiting unless otherwise specifically noted. For example, the functionality provided by the information storage system 120 and the processing system 130 may be combined in one computer system. Further, the functionality provided by the information storage system 120 and the processing system 130 may be distributed over several computer systems.

### Description of Fundamental Concepts

Real-time probabilistic prediction of future events and conditions is important and useful for systems used to predict and intercept certain objects. Typically, these systems are designed to address probabilistic situations of the following form:

A predicted event A is affected by a random vector X, which represents the kinematic state of an object to be intercepted at some time, and by a vector Y, which represents a set of random variables. The kinematic state of the object to be intercepted has been observed up to the current time by a sequence of observations Z=z, but the aforementioned random variables Y cannot be observed. Furthermore, Y and Z are independent. The challenge is the ability to determine, in real time, the conditional mean μ_{A} and variance σ_{A}² given the observations Z=z, of the conditional probability of A, given the random vectors X and Y:

μ_{A}=E(P(A|X,Y)|Z=z)

and

σ_{A}²=Var(P(A|XY)|Z=Z)

However, this determination may be reduced to a form that is more suitable for real time processing. Because Y and Z are independent of each other, Y does not directly affect the determination, so the determination reduces to:

μ_{A}=E(P(A|X)|Z=z)

and

σ_{A}²=Var(P(A|X)|Z=Z)

where the effect of Y has been integrated into the conditional probability P(A|X), which can be modeled offline. Thus, only the conditional mean and variance of P(A|X), given the observations Z=z, must be determined in real time.

The above determination can be approached in a different fashion that leads to an easy generalization. Let 1_{A} be a random variable, where:

$${1}_{A} = \{ \begin{matrix}1 & if event A occurs \\ 0 & otherwise\end{matrix} \} .$$

The conditional expectation of the random variable 1_{A} is the conditional expectation of the event A:

E(1_{A}|X)=P(A|X).

The simplified conditional mean and variance determinations described above is equivalent to

μ_{A}=E(E(1_{A}|X)|Z=Z)

and

σ_{A}²=Var(E(1_{A}|X)|Z=z).

In general, the challenge is to determine the conditional mean and variance given Z=z, of the conditional expectation of a random variable W at a future time given X and Y. As above, this determination reduces to determining:

μ_{W}=E(E(W|X)|Z=z),

and

σ_{W}²=Var(E(W|X)|Z=z).

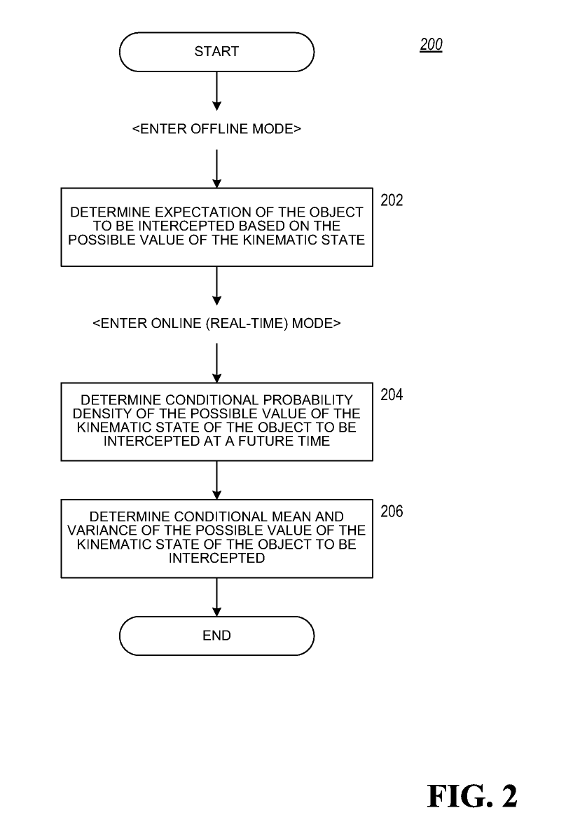

An approach 200 for determining the conditional mean and variance given the observations Z=z up to the current time has two parts, as illustrated in FIG. 2. In step 202, a function ƒ is constructed in an offline mode that approximates the conditional expectation:

ƒ(x)≈E(W|X=x),

where in this expression, x is a possible value of the kinematic state of the object to be intercepted at the future time of interest.

Then, during an online mode of the process 200, the conditional probability density function p_{x|z}(x|Z=z) of X at the future time given the observations Z=z up to the current time is determined in step 204. Ordinarily, both X and Z have Gaussian distributions, so this conditional probability density function is also Gaussian. In one approach, the conditional probability density function can be determined using a Kalman-type filter based on the work of Dr. Rudolf Emil Kalman.

In step 206, the conditional mean μ_{W} and variance σ_{W}² given the observations Z=z are determined:

μ_{W}=∫ƒ(x)p_{x|z}(x|z)dx,

and

σ_{W}²=∫(ƒ(x)−μ_{W})²p_{x|z}(x|z)dx.

The determination of the conditional mean and variance requires numerical integration techniques, because they are defined by integrals. The exemplary approaches to probabilistic object detection and interception described herein utilize an unscented transform to perform the numerical integration, and it is described in the following section.

### Unscented Transform

In general, the unscented transform approximates the mean and variance of a random variable Y=ƒ(X) in terms of the mean and covariance of X, where X is an n-dimensional random vector and ƒ is a nonlinear function. For purposes of describing the exemplary approach using the unscented transform, the conditioning on Z=z will not be referred to in the following sections.

In one exemplary approach, the approximation requires evaluating the function at 2n+1 points sᵢ, i=−n, . . . , n, referred to either as weighted samples or sigma points, and determining corresponding weights wᵢ, i=−n, . . . , n. Thus, if:

yᵢ=ƒ(sᵢ), i=−n, . . . , n,

then the mean of Y is:

$$E ( Y ) \approx {\sum }_{i = - n}^{n} {w}_{i} {y}_{i} ,$$

and the variance of Y is:

$$Var ( Y ) \approx {\sum }_{i = - n}^{n} {{w}_{i} ( {y}_{i} - E ( Y ) )}^{2} ,$$

where the sigma point s₀=E(X), the mean of X. The other sigma points lie on a covariance ellipsoid determined by the covariance of X, centered at the mean of X.

It is possible to adjust the size of the covariance ellipsoid by choosing a scale factor α. When α=1 (i.e., when the scale factor is equal to 1), the method is said to be unscaled. When α>1 (i.e., when the scale factor is greater than 1), the ellipsoid is larger, and when α<1 (i.e., the scale factor is less than 1), it is smaller. Further, when α≠1 (the scale factor is not equal to 1), the variance has an additional term:

$$Var ( Y ) \approx {\sum }_{i = - n}^{n} {{w}_{i} ( {y}_{i} - E ( Y ) )}^{2} ( 1 - {α}^{2} ) {( {y}_{0} - EY )}^{2} .$$

To determine the weights, an unscaled weight woo is first chosen for the center of the ellipsoid. The value

$${w}_{00} = \frac{1}{3}$$

is used in the preferred approach. Then set:

$${w}_{0} = \frac{{w}_{00} + {α}^{2} - 1}{{α}^{2}} ,$$

and

$${w}_{i} = \frac{1 - {w}_{00}}{2 n {α}^{2}} for i = 1 , … n and i = - 1 , … , - n .$$

To determine the sigma points, first determine the factorization of the covariance of X:

Cov(X)=CC^{T},

where C is lower triangular and the factorization is performed using the approach of André-Louis Cholesky. Let c₁, . . . , cₙ be the column vectors of the matrix C, so that:

C=[c₁c₂ . . . cₙ],

then set:

s₀=E(X),

s₁=s₀+αcᵢ for i=1, . . . n

and

sᵢ=s₀−αcᵢ for i=−1, . . . , −n.

The mean and variance of Y may then be determined as described above.

### Determination of the Probability of Successful Intercept of an Object to be Intercepted

In an aspect, the real-time object detection and interception system 100 provides a prediction of the probability of successful intercept of an object to be intercepted and assists in the successful intercept of the object to be intercepted. The prediction of successful intercepts is performed on a pair of objects—the object to be intercepted that is targeting some valued asset, and an intercepting object that may be used to attempt to engage the object to be intercepted. In the following description, it is assumed that the possible kinematic motion of the intercepting object is known and encapsulated in an object kinematics information database 122. In certain applications, the object kinematics information database 122 is implemented as a firing table.

For example, let A be the event or prediction that an object to be intercepted will be successfully intercepted; X be the kinematic state of the object to be intercepted at the proposed intercept time; Y be the vector of other random variables that affect the outcome of the intercept but can not be observed, such as the internal structure of the object to be intercepted. In an preferred aspect, the conditional probability of successful engagement P(A|X=x) is modeled offline as a function of the possible values x of the kinematic state X of the object to be intercepted at the proposed intercept time, integrating the effects of the unobservable random variables Y. The mean and variance of P(A|X) are determined in real time.

In one aspect, the object kinematics information database 122 stores pre-computed data needed for an intercepting object, also referred to as an interceptor, to intercept an object to be intercepted under standard conditions, and also the corrections that must be made for special conditions such as winds or variations of temperature. The information is indexed by range, azimuth, and elevation relative to the starting position of the interceptor. For a given range, azimuth, and elevation, there is an entry in the object kinematics information database 122 if there is an interceptor trajectory through the position with those coordinates. Two particular items of each entry are of particular interest: the time of travel of the interceptor and its velocity at the time it reaches that position, determined for the unique interceptor trajectory through that position. In some cases, the object kinematics information database 122 will be constrained in other ways. For example, there might be an entry for a given range, azimuth, and elevation only if the interceptor time of travel to that position is between a specified minimum and maximum time of travel.

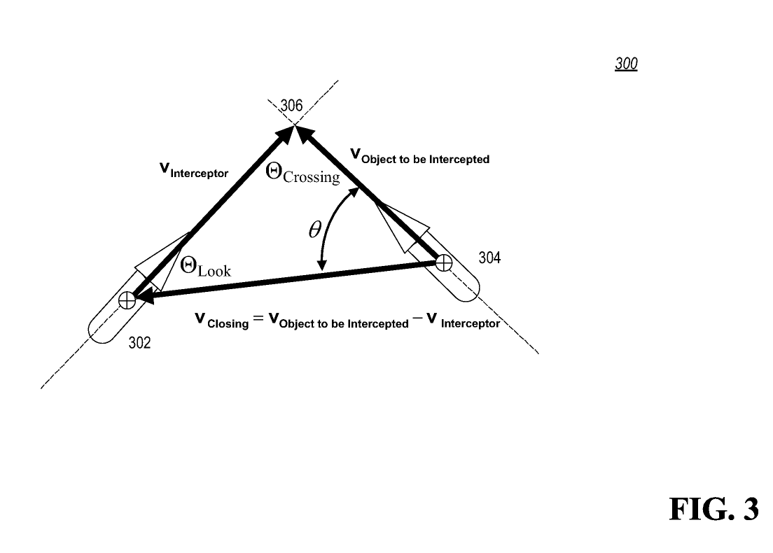

In an aspect, the descriptions contained herein make use of a model based on contact angle and closing speed. Closing speed is the magnitude of a relative velocity vector v_{closing}, which is determined based on a velocity vector v_{object} of an object to be intercepted and a velocity vector v_{interceptor} of an intercepting object. Contact angle is the angle between the centerline of the object to be intercepted and the relative velocity vector. FIG. 3 is a diagram illustrating an intercept endgame geometry for an interceptor 302 and an object to be intercepted 304, where θ is the contact angle and v_{closing} is the relative velocity vector as determined based on the velocity vectors v_{interceptor} and v_{object} of interceptor 302 and the object to be intercepted 304, respectively. As illustrated, both the object to be intercepted 304 and the interceptor 302 are aligned along their velocity vectors. The angle between the interceptor velocity vector and the relative velocity vector is referred to as the look angle Θ_{Look}, and the angle between the interceptor velocity vector and the threat velocity vector is referred as the crossing angle Θ_{Crossing}.

The closing speed provides for the determination of the kinetic energy transferred to be determined to the object to be intercepted. The rationale for using contact angle is as follows. In certain applications, the outcome of an attempted intercept is very sensitive to the miss distance of the interceptor from the ideal aimpoint. The ideal aimpoint is preferably on the centerline of the object to be intercepted at a specific distance behind the front of the threat object, with the specific distance depending on the type of object to be intercepted. The probability of successful intercept drops sharply when the miss distance exceeds a small threshold. To determine the ideal aimpoint, the interceptor must identify the front of the object to be intercepted. However, the probability of being able to do that correctly drops sharply when the contact angle exceeds either a minimum or maximum angle because then the front might not be clear or even visible.

In one approach, the conditional probability of successful intercept is approximated by a smooth function of contact angle and closing speed, which are themselves dependant on the position and velocity of the object to be intercepted at the proposed intercept time, as described above, where contact angle and closing speed depend directly on the velocity of the object to be intercepted and indirectly on its position, because its velocity depends on the position of the object to be intercepted. The function is of the form:

P_{K}(θₛₜᵣᵢₖₑ,ν_{closing})=p₀pₛₜᵣᵢₖₑ(θₛₜᵣᵢₖₑ)p_{closing}(ν_{closing}),

where

$${p}_{strike} ( {θ}_{strike} ) = \{ \begin{matrix}exp ( - 0.5 \frac{{( {θ}_{strike} - {θ}_{min critical angle} )}^{2}}{{σ}_{angle}^{2}} ) & if {θ}_{stike} < {θ}_{min critical angle} \\ 1.0 & if {θ}_{min critical angle} \leq {θ}_{strike} \leq {θ}_{max critical angle} \\ exp ( - 0.5 \frac{{( {θ}_{strike} - {θ}_{max critical angle} )}^{2}}{{σ}_{angle}^{2}} ) & if {θ}_{stike} > {θ}_{max critical angle}\end{matrix} \}$$

and

$${p}_{closing} ( {v}_{closing} ) = 1 = exp ( - \frac{{v}_{closing}}{{v}_{critical speed}} ) .$$

Assuming that the object to be intercepted is aligned along its velocity vector, the contact angle may be determined by:

$${θ}_{strike} = arc cos ( \frac{{v}_{threat}}{‖ {v}_{threat} ‖} \cdot \frac{{v}_{relative}}{‖ {v}_{relative} ‖} ) ,$$

while the closing speed may be determined by:

ν_{closing}=∥νᵣₑₗₐₜᵢᵥₑ∥,

where

vᵣₑₗₐₜᵢᵥₑ=vₜₕᵣₑₐₜ−v_{interceptor}.

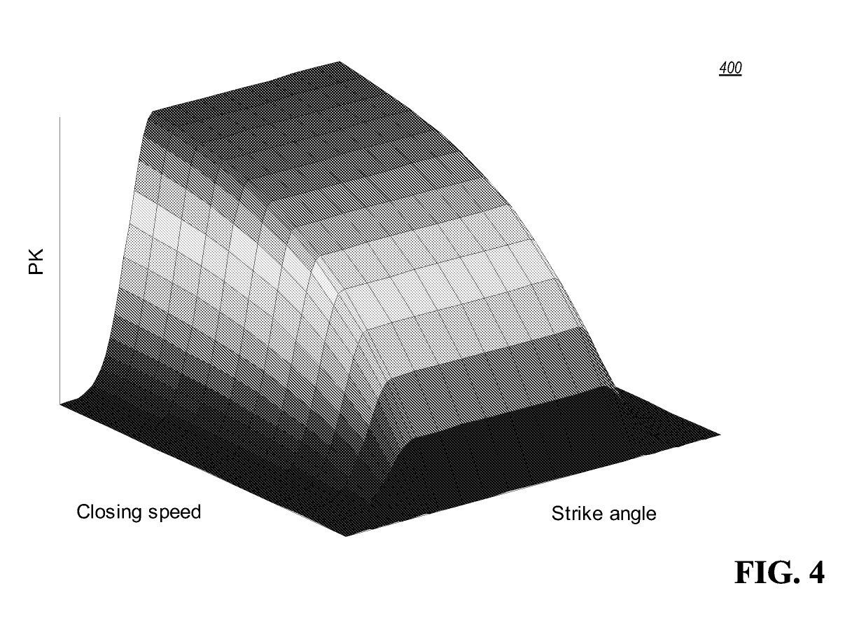

In these expressions, p₀, θ_{min critical angle}, θ_{max critical angle}, σ_{angle}², and ν_{critical speed} are model parameters. FIG. 4 illustrates a graph 400 of this conditional probability of successful intercept approach. The graph 400 shows the one-time engagement probability of successful intercept over an allowable range of contact angles and a reasonable range of closing speeds.

### Existing Approaches for Determining Probability of Intercept

Currently, there exist several approaches for determining probability of successful intercept, four of which will be discussed herein for background purposes. The four include: the threshold approach, the plug-in approach, the Taylor polynomial approach, and the Monte Carlo approach.

### Threshold Approach

The threshold approach decides whether a proposed engagement is acceptable or not, based on whether certain thresholds are satisfied. It assigns a predetermined positive probability of successful intercept to an acceptable engagement and zero probability of successful intercept to an unacceptable engagement.

For example, the decision can be based on thresholds for the predicted contact angle θ_{contact} and closing speed ν_{close} of the interceptor at the proposed intercept time. The proposed engagement is judged to be acceptable if:

θₘᵢₙ≦θ_{contact}≦θₘₐₓ,

and

ν_{close}≧νₘᵢₙ,

for predetermined minimum and maximum contact angles, θₘᵢₙ and θₘₐₓ, and minimum closing speed νₘᵢₙ.

The threshold approach propagates the estimated position and velocity of the object to be intercepted from the most recent track report time to the proposed intercept time. It performs this propagation by numerically solving the ordinary differential equation for a ballistic trajectory, typically using a fourth order Runge-Kutta approach as described by Carl David Tolmé Runge and Martin Wilhelm Kutta. The result is the predicted mean kinematic state of the object to be intercepted:

μ=E(X)

where:

X=(r^{T},v^{T})^{T}

is the combined vector of the predicted mean position and velocity of the object to be intercepted.

The threshold approach determines whether an intercept at the proposed intercept time is feasible. The intercept at that time is feasible if there is an interceptor trajectory passing through the predicted position of the object to be intercepted and if the time of travel of the interceptor to that position is short enough that the interceptor can be deployed and reach the intercept point at the same time as the object to be intercepted. The threshold approach checks both of these conditions by interpolating the kinematics information for all available interceptors to the range, azimuth, and elevation of the predicted position of the object to be intercepted. If it is possible to find one appropriate interceptor when there is an interceptor trajectory passing through the predicted position of the object to be intercepted. In that case, the threshold approach interpolates the information for the interceptor to obtain a time of flight. The time of flight is short enough if the time of flight is less than the difference between the proposed intercept time and the earliest possible interceptor deployment time.

If an intercept at the proposed intercept time is feasible, the threshold approach determines the contact angle and closing speed. The real-time object detection and interception system interpolates in the firing table to get the predicted velocity of the interceptor, determines the relative velocity, and determines the contact angle and closing speed.

If an intercept at the proposed intercept time is feasible, the threshold approach also determines whether the proposed engagement is acceptable by comparing the contact angle and closing speed to predetermined thresholds. Specifically, if the contact angle is between the predetermined minimum and maximum contact angle thresholds, and the closing speed is greater than the predetermined minimum closing speed, then the proposed engagement is acceptable, but otherwise it is not acceptable. If an intercept at the proposed intercept time is not feasible, then the proposed engagement is not acceptable.

If the proposed engagement is acceptable then the threshold approach reports the predetermined positive probability of successful intercept, but otherwise it reports zero probability of successful intercept.

A more refined version of the threshold approach would use thresholds to define several categories of acceptable engagements and assign a different probability of successful intercept to each category.

### Plug-In Approach

Another existing approach for determining probabilities of successful intercept is referred to as the plug-in approach. The plug-in approach determines an estimate of probability of successful intercept for a feasible proposed engagement and assigns zero probability of successful intercept to an infeasible proposed engagement. This approach depends on an approximation to the conditional probability of successful intercept given the position and velocity of the object to be intercepted at the proposed intercept time.

The conditional probability of successful intercept accounts for all uncertainties about the intercept except uncertainty about the position and velocity of the object to be intercepted. Those two variables are treated differently because information about them is available in real time. If the true position and velocity of the object to be intercepted at the proposed intercept time were known, the conditional probability of successful intercept would be the true probability of successful intercept for the proposed engagement.

The plug-in approach propagates the estimated position and velocity of the object to be intercepted from the most recent track report time to the proposed intercept time, similar to the threshold approach. The approach then determines whether an intercept at the proposed intercept time is feasible, also similar to the threshold approach.

If an intercept at the proposed intercept time is feasible, the approach determines the contact angle and closing speed, again similar to the threshold approach. The plug-in approach also determines the probability of successful intercept, if an intercept at the proposed intercept time is feasible, by plugging the estimated contact angle and closing speed. Otherwise, the approach sets the probability of successful intercept to zero.

Unlike the threshold approach, the plug-in approach does not categorize engagements on the basis of thresholds, so the probability of successful intercept is a smooth function of its parameters.

### Taylor Polynomial Approach

A Taylor polynomial approach approximates the function P_{K}(x) by its second degree Taylor polynomial about the mean kinematic state μ:

$${P}_{K} ( x ) \approx {P}_{K} ( μ ) + {P}_{K}^{( 1 )} ( μ ; x - μ ) + \frac{1}{2 !} {P}_{K}^{( 2 )} ( μ ; x - μ ) .$$

Using the properties of Gaussian distributions, the approach evaluates the mean of this polynomial explicitly:

$${μ}_{K} = E ( {P}_{K} ( X ) ) \approx {P}_{K} ( μ ) + \frac{1}{2 !} trace ( \sum H ) ,$$

where H is the Hessian of P_{K}(x). Moreover, the approach also evaluates the variance:

$${σ}_{K}^{2} = Var ( {P}_{K} ( {X}_{threat} ) ) \approx {\sum }_{i , j} {J}_{i} {\sum }_{ij} {J}_{j} + \frac{1}{2} {\sum }_{i , j} {H}_{ij} {H}_{kl} {\sum }_{ik} {\sum }_{jl} ,$$

where J is the gradient and H is the Hessian of P_{K}(x).

### Monte Carlo Approach

A straightforward Monte Carlo approach uses a random number generator to draw a sample {xᵢ, i=1, . . . , N} of size N from the probability distribution of X, P_{K}(x) is evaluated at each sample point, and approximates the mean and variance of P_{K}(X) by the sample mean and variance:

$${μ}_{K} = E ( {P}_{K} ( X ) ) \approx \frac{1}{N} {\sum }_{i = 1}^{N} {P}_{K} ( {x}_{i} ) ,$$

and

$${σ}_{K}^{2} = Var ( {P}_{K} ( X ) ) \approx \frac{1}{N - 1} {\sum }_{i = 1}^{N} {( {P}_{K} ( {x}_{i} ) - {μ}_{K} )}^{2} .$$

### Deficiencies of Current Approaches

The threshold approach has the virtues of simplicity and computational speed, but has several deficiencies. It provides unacceptably little information for use by an engagement planner because it does not distinguish between engagements with different probabilities of success. It is physically unrealistic in that it represents the probability of successful intercept as a step function; whereas physical processes ordinarily exhibit smooth behavior. It underestimates the useable environment, factors, and conditions by completely rejecting engagements whose contact angle or closing speed are even slightly outside the thresholds.

The plug-in approach is a big step forward from the threshold approach because it provides a good estimate of the mean probability of successful intercept when there is little uncertainty about the predicted position and velocity of the object to be intercepted. On the other hand, when there is substantial uncertainty about the predicted position and velocity of the object to be intercepted, the estimate is biased; that is:

P_{K}(μ)=P_{K}(E(X))≈EP_{K}(X)=μ_{K},

where the inequality occurs because P_{K}(x) is a nonlinear function.

The bias can be significant when the kinematic state covariance of the object to be intercepted is large. That can happen in several circumstances: the track of the object to be intercepted has not yet converged, the object to be intercepted is changing its speed or position (e.g., maneuvering), or the predicted track of the object to be intercepted has been propagated well into the future. The track may be propagated into the future—by not just seconds but minutes, to support the user.

The Taylor polynomial approach generates an unbiased estimate of the mean and, unlike the others, an estimate of the variance of P_{K}(X) that is accurate to the second order. The approach is quite fast because it only requires evaluating the explicit expressions for mean and variance. However, those expressions involve the gradient and Hessian of the function P_{K}(x), which are difficult to derive and implement for any but the simplest models of a successful intercept.

The Monte Carlo approach can achieve arbitrarily accurate estimates of the mean and variance of P_{K}(X), but is far too slow for use in a real-time system. However, it is valuable for offline assessment of the accuracy of the other approaches.

### Probabilistic Approach for Object Interception

The exemplary real-time object detection and interception system described herein determines an unbiased estimate of the probability of successful intercept and, in addition, the variance of probability of successful intercept. In one preferred aspect, the real-time object detection and interception system uses the following approximation to the conditional probability of successful intercept given the position and velocity of the object to be intercepted at the proposed intercept time:

P_{K}(x)≈P(intercept|x)

The real-time object detection and interception system 100 numerically determines both the mean and the variance of probability of successful intercept:

$${μ}_{K} = E ( {P}_{K} ( X ) ) \\ = \int {P}_{K} ( x ) ϕ ( x ) d x ,$$

and,

$${σ}_{K}^{2} = E ( {{P}_{K} ( X )}^{2} ) - {E ( {P}_{K} ( X ) )}^{2} \\ = \int {{P}_{K} ( x )}^{2} ϕ ( x ) d x - {μ}_{K}^{2} .$$

In one preferred aspect, the real-time object detection and interception system 100 performs these determinations using the unscented transform.

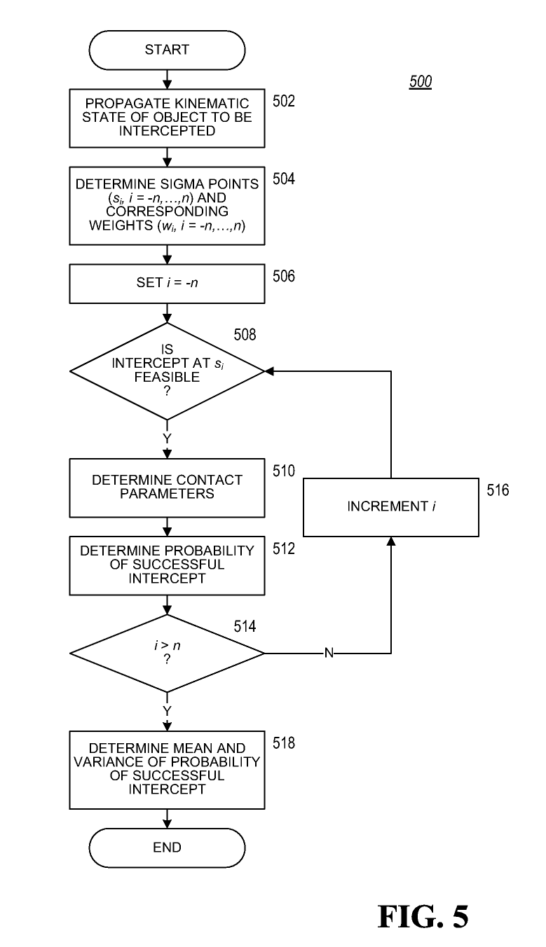

FIG. 5 illustrates a probabilistic process 500 that is an exemplary implementation of the probability determination performed by the real-time object detection and interception system 100, where, in step 502, the mean kinematic state of the object to be intercepted is propagated from the most recent track report time to the proposed intercept time. In addition, it propagates the error covariance of the kinematic state of the object to be intercepted. The result is the predicted mean μ and covariance Σ of the kinematic state of the object to be intercepted.

In step 504, the sigma points sᵢ, i=−n, . . . , n and the corresponding weights wᵢ, i=−n, . . . , n are determined.

For each sigma point sᵢ, a probability of successful intercept is determined if an intercept at sᵢ is feasible. Thus, in step 506, a counter is set to the value of −n which will eventually be allowed to run through the value of n. In another approach, the counter is set to 1 and the process is allowed to loop through 2×n iterations.

In step 508, it is determined whether an intercept at sᵢ is feasible. In an aspect, an intercept is feasible where certain criteria are met. The criteria are not necessary the same for every scenario, but would include criteria like the object to be intercepted being within the kinematic range of the interceptor, or that there is sufficient time for the interceptor to reach the object to be intercepted before it goes out of range or reaches its destination. If an intercept at sᵢ is feasible, then operation continues with step 510, where a plurality of contact, or endgame, parameters are determined.

In step 510, contact parameters such as the contact angle and closing speed of the interceptor and the object to be intercepted are determined. Further, if an intercept at sᵢ is feasible, in step 512 the probability of successful intercept is determined by using the estimated contact angle and closing speed, but otherwise it sets the probability of successful intercept to zero. In one exemplary approach, the function ƒ(sᵢ)=P_{K}(sᵢ) is used. In an aspect, an intercept is considered successful if the interceptor will be able to contact the object to be intercepted and eliminate, or significantly reduce, the effectiveness of the object to be intercepted. In security and defense applications, for example, a successful intercept is where the interceptor can prevent the object to be intercepted from imparting any significant damage.

In step 514, it is determined if all sigma points have been processed. In one approach, this is determined by checking the value of i to see if it is larger than the total number (2n+l) of sigma points. If more sigma points need to be processed, then operation continues with step 516, where the counter i is incremented. If all sigma points have been processed, then operation continues with step 518.

In step 518, the mean and variance of probability of successful intercept are determined by combining the results from step 508 through step 512 and using the following equations:

$${μ}_{K} = E ( {P}_{K} ( X ) ) \\ = \int {P}_{K} ( x ) ϕ ( x ) d x ,$$

and,

$${σ}_{K}^{2} = E ( {{P}_{K} ( X )}^{2} ) - {E ( {P}_{K} ( X ) )}^{2} \\ = \int {{P}_{K} ( x )}^{2} ϕ ( x ) d x - {μ}_{K}^{2} ,$$

where the integration is performed using the unscented transform as discussed above.

The probabilistic approached used by the real-time object detection and interception system determines an unbiased estimate of the mean probability of successful intercept and is dependent on the specific conditions of the planned intercept. In contrast, the threshold approach reports one of only two possible predetermined values; and is barely sensitive to the specific conditions of the planned intercept. The plug-in approach is sensitive to the specific conditions of the planned intercept, but determines a biased estimate of the mean probability of successful intercept because the conditional probability of successful intercept is a nonlinear function of the predicted mean of the kinematic state of the object to be intercepted.

Second, the probabilistic approach also determines the variance of probability of successful intercept, unlike both the threshold approach and the plug-in approaches.

Third, the probabilistic approach is easy to derive and implement. It requires evaluating only the function P_{K}(x) itself at a small number of points and does not require deriving or evaluating the gradient or Hessian.

The probabilistic approach generates an estimate of the mean probability of successful intercept that is more accurate than the threshold and plug-in approaches, while providing a measure of the quality of the estimate. Critically, the probabilistic approach permits the analysis to be computed in a real-time manner.

The exemplary probabilistic approach described herein can be expanded to include additional factors and variables for specific scenarios. In another exemplary approach, the probability of successful intercept is determined by taking into account the ability of the interceptor to acquire the object to be intercepted and maneuver to better engage the object to be intercepted.

P(intercept|X=x)=P(intercept|divert,X=x)P(divert|acquisition,X=x)P(acquisition|X=x)′

where divert refers to the ability of the interceptor to maneuver or alter its trajectory, and acquisition refers to the ability of the interceptor—where the interceptor includes an on-board sensor, to identify the object that it is supposed to intercept. Thus, P(intercept|divert, X=x) is the conditional probability of successful intercept given successful divert and the kinematic state; P(divert|acquisition,X=x) is the conditional probability of successful divert given successful acquisition and the kinematic state; and P(acquisition|X=x) is the conditional probability of successful acquisition given the kinematic state. In this more sophisticated approach, the function just described is considered to be the conditional probability of intercept, given successful acquisition of the object to be intercepted by the onboard seeker of the interceptor and successful divert by the interceptor. In another exemplary approach, the acquisition component may be excluded if the interceptor is guided by an external control source that includes a sensor. Various combinations of these and other conditionals may be used.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The teachings herein may be incorporated into (e.g., implemented within or performed by) a variety of apparatuses (e.g., devices). Accordingly, one or more aspects taught herein may be incorporated into a computer (e.g., a laptop), a portable communication device, an image processing system (e.g., a radar or photo image processing system), a portable computing device (e.g., a personal data assistant), a global positioning system device, or any other suitable device that is configured to perform image processing.

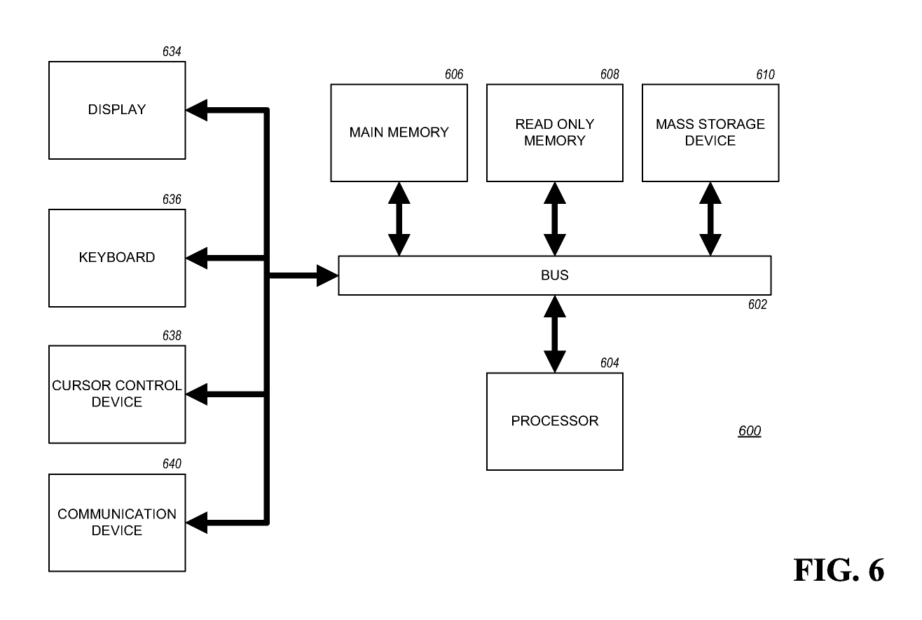

FIG. 6 illustrates an example of a computer system 600 in which certain features of the exemplary real-time object detection and interception system may be implemented. Computer system 600 includes a bus 602 for communicating information between the components in computer system 600, and a processor 604 coupled with bus 602 for executing software code, or instructions, and processing information. Computer system 600 further comprises a main memory 606, which may be implemented using random access memory (RAM) and/or other random memory storage device, coupled to bus 602 for storing information and instructions to be executed by processor 604. Main memory 606 also may be used for storing temporary variables or other intermediate information during execution of instructions by processor 604. Computer system 600 also includes a read only memory (ROM) 608 and/or other static storage device coupled to bus 602 for storing static information and instructions for processor 604.

Further, a mass storage device 610, such as a magnetic disk drive and/or a optical disk drive, may be coupled to computer system 600 for storing information and instructions. Computer system 600 can also be coupled via bus 602 to a display device 634, such as a cathode ray tube (CRT) or a liquid crystal display (LCD), for displaying information to a user so that, for example, graphical or textual information may be presented to the user on display device 634. Typically, an alphanumeric input device 636, including alphanumeric and other keys, is coupled to bus 602 for communicating information and/or user commands to processor 604. Another type of user input device shown in the figure is a cursor control device 638, such as a conventional mouse, touch mouse, trackball, track pad or other type of cursor direction key for communicating direction information and command selection to processor 604 and for controlling movement of a cursor on display 634. Various types of input devices, including, but not limited to, the input devices described herein unless otherwise noted, allow the user to provide command or input to computer system 600. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 600 may optionally include such devices as a video camera, speakers, a sound card, or many other conventional computer peripheral options.

A communication device 640 is also coupled to bus 602 for accessing other computer systems or networked devices, as described below. Communication device 640 may include a modem, a network interface card, or other well-known interface devices, such as those used for interfacing with Ethernet, Token-ring, or other types of networks. In this manner, computer system 600 may be coupled to a number of other computer systems.

The various illustrative logical blocks, modules, and circuits described in connection with the aspects disclosed herein may be implemented within or performed by an integrated circuit (“IC”). The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded the widest scope consistent with the principles and novel features disclosed herein.

What is claimed is:

1. A system for determining a probability of interception by an interceptor of an object to be intercepted comprising:
means for propagating a kinematic state of the object to be intercepted;
means for determining a plurality of probabilities of intercept;
means for determining whether an intercept is feasible and creating a set of probabilities of successful intercept for each probability of intercept; and
means for determining the mean and variance of probability of successful intercept based on the set of probabilities of successful intercept.

2. The system of claim 1, wherein the kinematic state comprises a mean value of the kinematic state of the object to be intercepted.

3. The system of claim 1, wherein the kinematic state comprises a covariance value of the kinematic state of the object to be intercepted.

4. The system of claim 1, wherein the means for determining the probabilities of intercept includes means for determining a probability of intercept for each measured and predicted kinematic state.

5. The system of claim 1, wherein the probability of successful intercept is determined by using an estimated contact angle and closing speed.

6. The system of claim 1, wherein the probability of successful intercept is determined based on a probability that the interceptor will be able to contact the object to be intercepted and at least significantly reduce the effectiveness of the object to be intercepted.

7. A method for determining a probability of interception by an interceptor of an object to be intercepted comprising:
propagating a kinematic state of the object to be intercepted;
determining a plurality of probabilities of intercept;
for each probability of intercept, determining whether an intercept is feasible and creating a set of probabilities of successful intercept; and
determining the mean and variance of probability of successful intercept based on the set of probabilities of successful intercept.

8. The method of claim 7, wherein the kinematic state comprises a mean value of the kinematic state of the object to be intercepted.

9. The method of claim 7, wherein the kinematic state comprises a covariance value of the kinematic state of the object to be intercepted.

10. The method of claim 7, wherein determining the probabilities of intercept includes determining a probability of intercept for each measured and predicted kinematic state.

11. The method of claim 7, wherein the probability of successful intercept is determined by using an estimated contact angle and closing speed.

12. The method of claim 7, wherein the probability of successful intercept is determined based on a probability that the interceptor will be able to contact the object to be intercepted and at least significantly reduce the effectiveness of the object to be intercepted.

13. A system for real-time determination of interception probability for a threatening object by an interceptor comprising:
an objects kinetics information storage unit configured to store a kinematic state of the object to be intercepted;
an intercept probability determination unit configured to determine a plurality of probabilities of intercept for the object to be intercepted; and,
a variance and means determination unit configured to determine the mean and variance of probability of successful intercept based on the set of probabilities of successful intercept.

14. The system of claim 13, wherein the variance and means determination unit comprises an unscented transformation unit.

15. The system of claim 13, wherein the kinematic state comprises a mean value of the kinematic state of the object to be intercepted.

16. The system of claim 13, wherein the kinematic state comprises a covariance value of the kinematic state of the object to be intercepted.

17. The system of claim 13, wherein the intercept probability determination unit is configured to determine a probability of intercept for each measured and predicted kinematic state.

18. The system of claim 13, wherein the probability of successful intercept is determined by using an estimated contact angle and closing speed.

19. The system of claim 13, wherein the probability of successful intercept is determined based on a probability that the interceptor will be able to contact the object to be intercepted and at least significantly reduce the effectiveness of the object to be intercepted.
